(19) United States
(12) Patent Application Publication
(10) Pub. No.: US 2003/0132283 A1
(43) Pub. Date: Jul. 17, 2003

(54) Method for utilizing smart cards for storing training and simulation information

(76) Inventors: Andrew Wesley Hobgood, Goffstown, NH (US); John Franklin Ebersole JR., Bedford, NH (US); John Franklin Ebersole, Bedford, NH (US)

Correspondence Address: Brian M. Dingman, Esq., Mirick, O'Connell, DeMallie & Lougee, LLP, 1700 West Drive, Westborough, MA, 01581, US

(21) Appl. No.: 10/215,419

(22) Filed: Aug. 8, 2002

Related U.S. Application Data
(60) Provisional application No. 60/348,568, filed on Jan. 15, 2002.

(51) Int. Cl. G06K 5/00

(52) U.S. Cl. 235/380

(57) ABSTRACT

The application describes a method for utilizing smart card technology with computer-based training systems. Training and simulation data, including, but not limited to, personal and/or team training profiles, instructor information, training parameters, and simulation scenarios can be stored on the smart card for retrieval prior to future training activities. New training results can be added to existing results to track individual trainee or team progress. The computer-based training may be graphical, completely or partially simulated, or textual. The cards may also store information in the form of a database, which can be used to increase the flexibility of training scenarios.

### CROSS REFERENCE TO RELATED APPLICATION

This application claims priority of Provisional patent application 60/348,568 filed Jan. 15, 2002.

### FIELD OF THE INVENTION

This invention relates to smart card technology, computer-based training, performance metrics, and identity tracking within a training and simulation environment. This method defines a way to use smart cards to track and confirm user identity and to track performance data for use in computer-based training systems.

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

Smart cards have been used in a variety of fields for years because they provide cost-efficient, space-saving, paperless, and secure storage of data. Utilization of smart card technology can be found in the fields of banking, retail, biomedical, and personal security. In these fields, smart cards are commonly used to store financial data (such as personal account information and pricing/cost data for retail applications), medical information (such as treatment plans and history, surgical procedures, and prescription data), and personal identification information (such as fingerprints, numerical identifiers, and passwords). In many of these instances, the smart card not only serves as a data storage device, but also as a “passport” into a system in which the data stored requires protection measures to maintain security and/or privacy.

### SUMMARY OF THE INVENTION

Training in many professions is accomplished via computer-based simulation or other computer-based method. Smart card technology can be used with any computer-based method of training, including simulations such as virtual reality. Data stored on a smart card (for example, training history and skills previously mastered) can be readily available prior to a training session—knowledge of training history facilitates appropriate placement for new training activities. Additional relevant data stored on a smart card could include testing parameters, team interactions, prior test results, and computer-generated scenarios. The smart card also offers protection of computer-based training information (tests and test results, personal identification information, etc.) through use of one or more protection features. Smart cards are appropriate for individual, team and instructor storage of training and simulation information.

The invention features a method for utilizing smart card technology for storage of training and simulation data in computer-based training systems. In addition to a smart card, equipment required includes a smart card read/write terminal and a computer with a display device such as a monitor. The type of data stored can include, but is not limited to, personal and/or team training profiles, instructor information such as tests, training parameters, and simulation scenarios (such as virtual reality) to be used for computer-based training activities. The data stored on the card is retrieved prior to the start of a training session and used to tailor the session to meet training needs accordingly. The data acquired during the training session can be recorded on the card and used to track progress and skill mastery for individuals or teams. The display with which the trainee interacts may be graphical, simulated (as in virtual reality), partially simulated (as in augmented reality), or textual (as in a testing situation). Uses in specific training applications include storing emergency first responder training information such as fire and extinguishing agent data and data relating to injuries likely occur as a result.

### BRIEF DESCRIPTION OF THE DRAWINGS

FIG. 1 shows the opening screen of the preferred embodiment of the invention embodied with a software training tool, which shows who the card belongs to and what the recent history of training activity has been.

FIG. 2 shows a screen evidencing a scenario where a fire began and then the trainee extinguished the fire.

FIG. 3 shows the output screen after the above scenario ended, summarizing the results of the scenario.

FIG. 4 shows the output screen after the above scenario ended, showing how many points the trainee gained in putting out this fire.

FIG. 5 schematically depicts the basic hardware required to enable the inventive method.

### DETAILED DESCRIPTION OF THE PREFERRED EMBODIMENTS OF THE INVENTION

The inventive method uses smart card technology to store pertinent training and simulation data, including but not limited to, one or more of training information, trainee and team performance data, simulation parameters, metrics, and other information related to training, simulation, and/or evaluation. The relevant data is stored on the smart card and is accessed via a smart card terminal. The terminal can be connected to either the simulation computer or to a separate computer being used for analysis. The smart card terminal provides access to the data upon insertion of the smart card. Data on the smart card (from previous training session, for example) can be retrieved and can also be updated to reflect the trainee's most recent performance. A “smart card” is a digital rewriteable memory device in a shape like a credit card, that can be read and written by a smart card terminal.

Computer-based simulation of specific scenarios is a frequently used method of training. One common type of computer-based simulation and training is virtual reality (VR). In VR, a trainee is interacting with an entirely simulated environment (or with some type of simulator equipment) in order to accomplish a particular task. Smart cards can be used to store data from current and previous VR training sessions. That data can include trainee identification information, simulation data for the virtual environment, and metrics regarding the trainee's performance in one or more given scenarios. For example, training for driving an automobile under difficult conditions (such as law enforcement high-speed driving) can be done with a driving simulator. The trainee would enter the simulator, insert his/her smart card into the smart card terminal and be identified based on information stored on the smart card. The smart card would also contain information such as chase parameters (e.g., speed, visibility type of vehicle, road conditions). The scenario could be run and the trainee's interaction with the scenario (the trainee's performance) can be recorded and stored on the card. Those results can be called up later to evaluate progress in a given skill or other “lessons learned.” Likewise, by storing simulation information on a smart card, training scenarios can be repeated any number of times in a cost-efficient and reliable manner. Specifically, an instructor could have one smart card with a set of scenarios that can be run at the instructor's discretion. The instructor can administer the same scenario, perhaps as a test, to multiple trainees with minimal risk of instructor error, thus providing more valid test results.

Another method of computer-based simulation and training is augmented reality (AR). In AR, a trainee is interacting with computer-generated graphical elements which “augment” the trainee's view of his/her actual environment. Much like smart cards used in VR training, smart cards used in AR training store data from current and previous AR training sessions. Data can include trainee identification information, simulation data for the computer-generated graphical elements, and metrics regarding the trainee's performance in one or more given scenarios. The field of law enforcement can again be cited as an example when this method would be useful. With AR, weapons practice can occur within an environment more like an actual incident scene (e.g., perhaps a parking lot). Smart card stored computer-generated graphical elements could include one or more targets, possible victims, and ammunition as expelled from a device used to simulate a weapon. The trainee would insert his/her smart card into the smart card terminal, be identified based on information stored on the smart card, and begin the simulation. The scenario could be run and the trainee's performance recorded and stored on the smart card. Results are called up later for evaluation purposes. Similarly, an instructor-used smart card containing AR simulation information facilitates repeatability of scenarios.

Any computer-based training and simulation can utilize smart card technology. For example, unlike VR and AR, some training applications (e.g., interactive personnel placement/allocation trainers) use 2D-graphical user interfaces. The method described herein can be used to store data specific to this situation. This method is also applicable to training or evaluation presented via a textual interface (e.g., a simple exam application or other evaluation tool).

The smart card can be used to store any type of data relevant to a particular training situation. When the type of scenario presented must be tailored to what could be referred to as a trainee's personal training profile (identifying personal information and other data), that information can be stored on the smart card. This data might include, but is not limited to, skills mastered, levels of expertise or other special training, and training needed for upcoming assignments. Likewise, the method featured in this application can also be used to store instructor data on a smart card. Examples include authentication of an instructor into a training system for purposes of security or access control; or simply to provide the system with the instructor's personal training profile for the purpose of tailoring the application to the instructor.

Performance data (interaction with training scenarios) such as success, score, or other parameters for individual trainees and for teams can be stored on a smart card. Furthermore, applications which have a notion of a “team” can store information about the user's participation within the team, the user's performance in the context of the team, and/or the performance of the team as a whole.

Training application parameters, such as locations of hazards, size of training space, or any other parameter of the application, can be stored on the smart card. The result is the creation of “scenario” cards containing the specific data required by the simulation or training application. Furthermore, multiple smart cards can be used to track multiple users and multiple scenarios.

Security of information contained on the smart card may be of concern to the smart card user. Smart card data can be protected using a number of methods. The card can be protected via a personal identification number (PIN). This provides a security layer such that the card used is authenticated by the owner. That is, if a user enters the correct PIN to obtain the data from the card, it can be safely assumed that the user is the valid owner of the card, thus preventing identity theft in the training environment. Another method of protection is to issue a password for use of the card. As with use of a PIN, if a card user enters the correct password, it is assumed that the user is the card owner. The smart card can also be protected via a cryptographic “handshake.” In this case, the contents of the card are protected via mathematically secure cryptography requiring secure identification of any system requesting data from the card. This can prevent unauthorized systems or users from accessing the data that exists on the card.

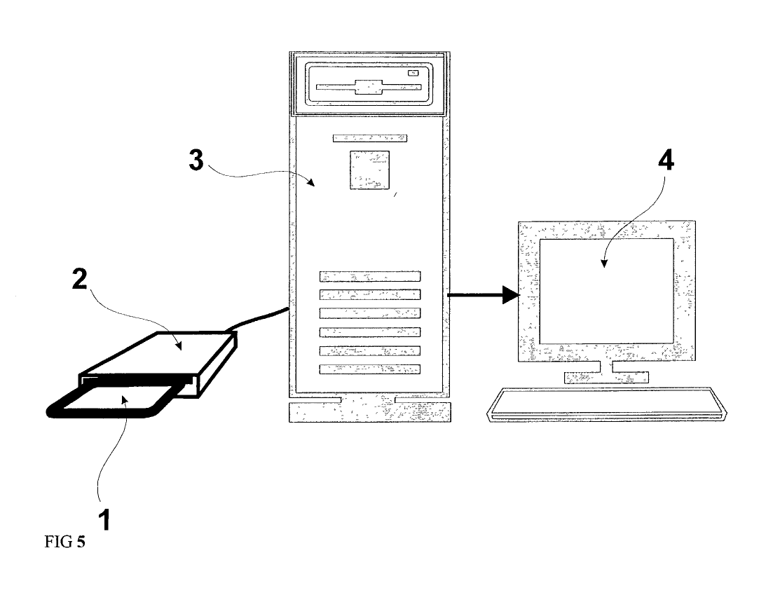

Use of the smart card 1 (FIG. 5) requires a smart card terminal 2. The smart card terminal 2 is a read-write device which allows the data on the card 1 to be retrieved for use in the system 3 and new data to be written to the card 1 for use in the future. It can be connected directly to the computer(s) 3 which running the training application, displaying the output of the smart card and training simulation on the output display 3. This is most practical when the training environment has a computer 3 that can execute the training scenario readily available and a situation involving only one trainee. The method featured in this application also allows training via networked communication. The smart card terminal can be connected to a separate computer which is connected (via standard networking cables) to the computer(s) running the training application. For example, if a local computer can accommodate use of the smart card terminal, but not the training scenario, the training scenario can be directed to another computer on the network and used at a local, more convenient location.

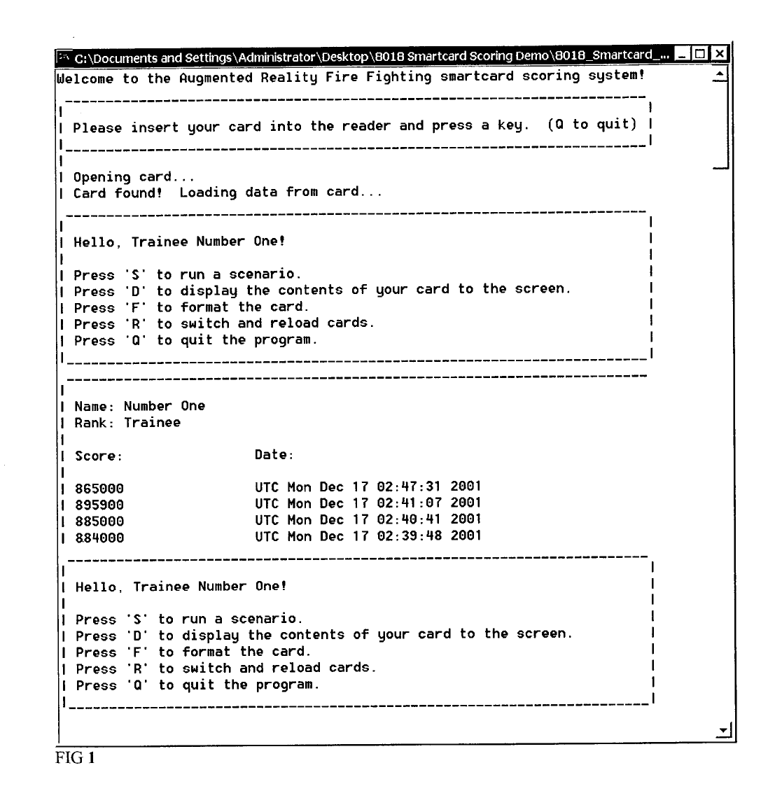

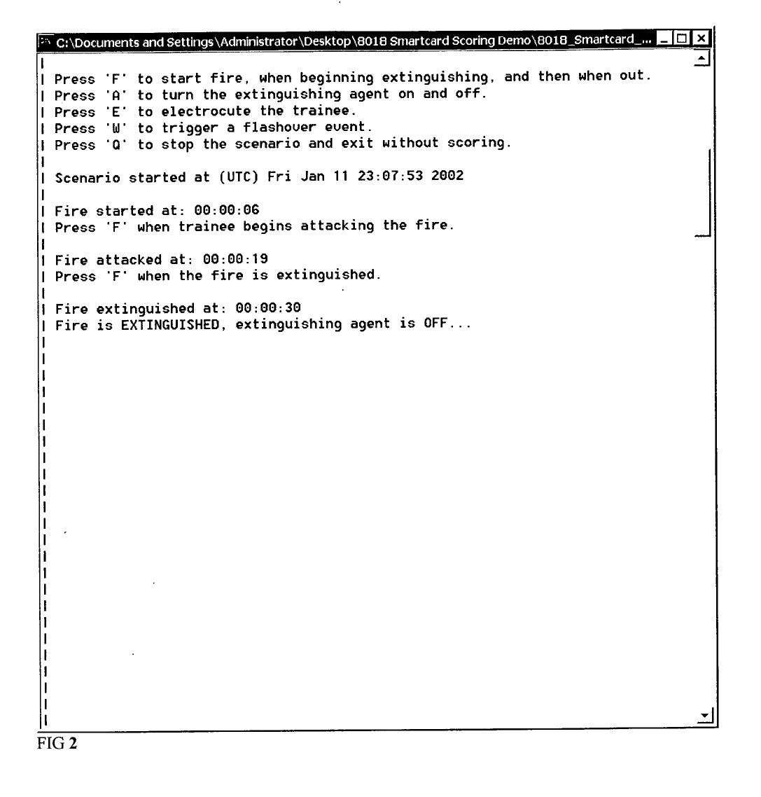

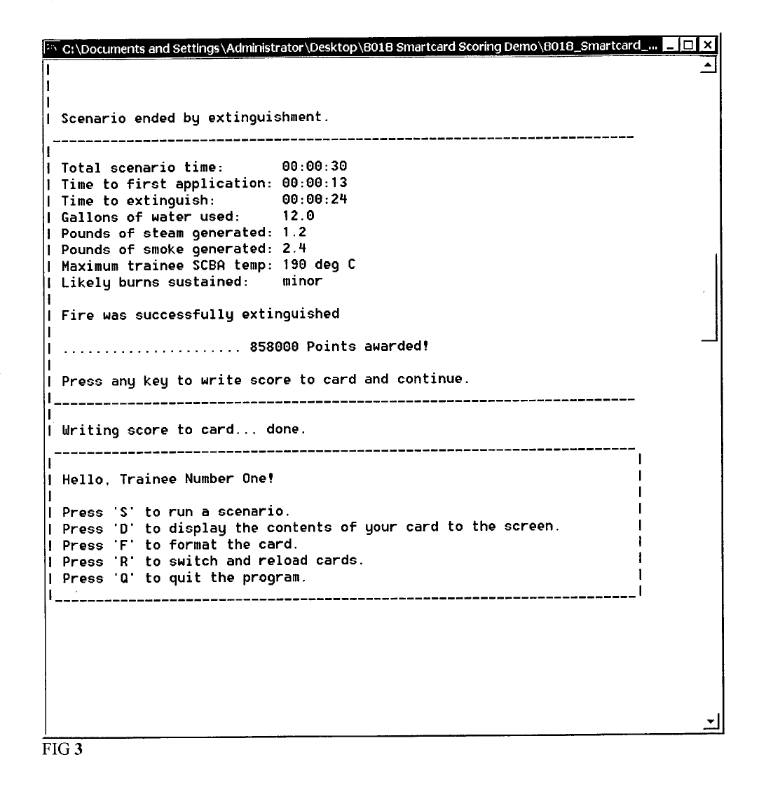

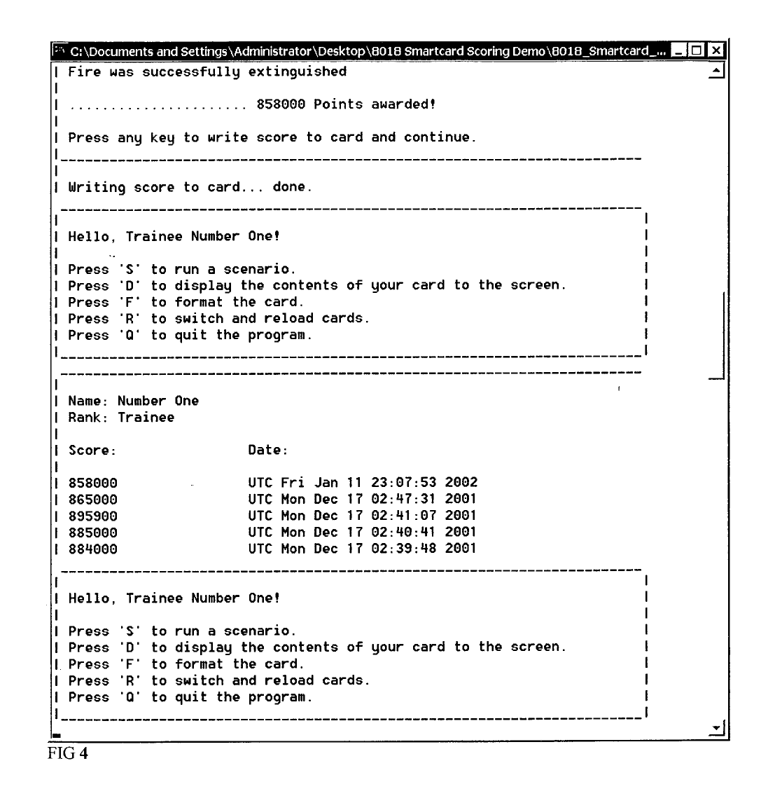

One very specific use of this method involves the situation where a system is being used to train firefighters/damage control personnel. The data stored on the smart card is used to track and store fire/damage extent, length of time fires burned, amount of water or other extinguishing agent used to put out the fire, relative score, and any potential injury that is likely to have been sustained by the trainee(s) or equipment. The opening screen of an application for one embodiment of this method is shown in FIG. 1. This screen contains information about the identity of the cardholder, and shows a log of previous training scenarios and the score attained for each one. When running a scenario, data about the current status of the scenario is shown as in FIG. 2. After the scenario ends, performance statistics are presented to the trainee, and a score is generated and written to the card, as shown in FIG. 3. FIG. 4 shows the log of recent training scenarios again as in FIG. 1, but includes the most recent training scenario depicted in FIG. 2 and FIG. 3.

Other potential applications of this method include operational scenarios, in which a user's operational performance can be recorded and reviewed. For instance, in an air traffic control scenario, the system may track any close calls, as well as performance data related to the number of aircraft on the controller's screen, the most busy time of day, average radio transmission length, and other metrics. These metrics as stored on the smart card represent a personal performance profile that can be used for evaluation of the controller, or as a tamper-resistant record of the controller's actions. Such a system would expand performance evaluation beyond training and into daily use, providing improved on-the-job safety and efficiency.

What is claimed is:

1. A method for utilizing smart card technology for storage of performance metrics and user information, comprising:
providing a smart card;
providing a smart card terminal; and
reading from and writing user information to the smart card using the smart card terminal.

2. The method of claim 1 in which the metrics and information stored are used in an operations system.

3. The method of claim 1 in which the metrics and information stored are used in a training and simulation system.

4. The method of claim 3 in which the smart card contains the trainee's personal training profile.

5. The method of claim 3 in which the smart card contains the instructor's personal training profile.

6. The method of claim 3 in which the method is used in the training of firefighters/damage control personnel.

7. The method of claim 1 in which the smart card contains the user's personal performance profile.

8. The method of claim 3 in which the system uses virtual reality (VR).

9. The method of claim 3 in which the system uses augmented reality (AR).

10. The method of claim 1 further comprising providing a 2D graphical user interface.

11. The method of claim 1 further comprising providing a textual interface.

12. The method of claim 1 in which the smart card contains performance data for a team.

13. The method of claim 1 in which the smart card contains system parameters.

14. The method of claim 1 in which multiple smart cards are used.

15. The method of claim 1 in which the smart card is protected from being read using a personal identification number (PIN).

16. The method of claim 1 in which the smart card is protected from being read using a password.

17. The method of claim 1 in which the smart card is protected from being read using a cryptographic handshake.

18. The method of claim 1 further comprising one or more computers running the system, in which the smart card terminal is directly connected to at least one such computer.

19. The method of claim 18 further comprising a separate computer connected to at least one computer running the system, in which the smart card terminal is connected to the separate computer by networked communications.

20. The method of claim 2 in which the system uses virtual reality (VR).

21. The method of claim 2 in which the system uses augmented reality (AR).
